(19) United States
(12) Patent Application Publication
(10) Pub. No.: US 2006/0181336 A1
(43) Pub. Date: Aug. 17, 2006

(54) Bandgap reference voltage generator without start-up failure

(75) Inventors: Dae-gyu Lee, Seongnam-si (KR); Jae-joon Moon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/328,236

(22) Filed: Jan. 10, 2006

(30) Foreign Application Priority Data
Feb. 11, 2005 (KR) 2005-0011661

(51) Int. Cl. G05F 1/10

(52) U.S. Cl. 327/539

(57) ABSTRACT

Provided is a bandgap reference voltage generator without a start-up failure, including: a reference voltage generator, generating a bandgap reference voltage; a current provider providing a start-up current to the reference voltage generator using a predetermined power; and if the current provider fails to provide the start-up current to the reference voltage generator, a current providing support providing the start-up current to the reference voltage generator using the predetermined power used by the current provider. Therefore, when the bandgap reference voltage generator starts up by itself at an initial driving, a start-up failure does not occur. Thus, other electric elements integrated into an integrated circuit element can be supplied with a rated bandgap reference voltage and thus normally operate.

### CROSS-REFERENCE TO RELATED APPLICATIONS

This application claims priority from Korean Patent Application No. 2005-11661 filed Feb. 11, 2005, in the Korean Intellectual Property Office, the disclosure of which is incorporated herein by reference.

### BACKGROUND OF THE INVENTION

1. Field of the Invention

The present invention relates to a bandgap reference voltage generator, and more particularly, to a bandgap reference voltage generator generating a bandgap reference voltage and applying the bandgap reference voltage to an electric element requiring the bandgap reference voltage.

2. Description of the Related Art

Bandgap reference voltage generators are integrated with other electric elements into integrated circuit (IC) elements. Such a bandgap reference voltage generator generates a bandgap reference voltage and applies the bandgap reference voltage to electric elements requiring the bandgap reference voltage.

FIG. 1 is a circuit diagram of a conventional bandgap reference voltage generator. Referring to FIG. 1, the conventional bandgap reference voltage generator includes an operational amplifier (OP-Amp), resistors R1, R2, and R3, and bipolar transistors Q1, Q2, Q3, and Q4 that are connected to one another.

The bipolar transistors Q1 and Q2 change a current flowing with a variation in temperature to adjust an input voltage applied to a negative input node of the OP-Amp, and the resistor R3 and the bipolar transistors Q3 and Q4 change a current flowing with a variation in temperature to adjust an input voltage applied to a positive input node of the OP-Amp. Also, the resistor R1 feeds an output of the OP-Amp back to the negative input node of the OP-Amp, and the resistor R2 feeds the output of the OP-Amp back to the positive input node of the OP-Amp. The OP-Amp amplifies differential input voltages input through the positive and negative input nodes thereof with a predetermined gain to generate and output a bandgap reference voltage V_{BGR}.

The bandgap reference voltage generator shown in FIG. 1 must be supplied with a start-up power at an initial driving. In other words, the start-up power must be applied to Node 1 of the bandgap reference voltage generator, and thus an additional start-up power circuit must be provided.

A bandgap reference voltage generator capable of starting up by itself has been suggested to solve this problem. Such a bandgap reference voltage generator is shown in FIG. 2. FIG. 2 is a circuit diagram of a conventional bandgap reference voltage generator capable of starting up by itself.

A circuit structure of the bandgap reference voltage generator shown in FIG. 2 is different from the circuit structure of the bandgap reference voltage generator shown in FIG. 1 in that a P-channel MOS FET (MP) is added. In detail, gate, source, and drain nodes of the MP are respectively connected to an output node of an OP-Amp, ends of resistors R1 and R2, and a bias power Vcc.

The MP provides a path through which an output of the OP-Amp is fed back to an input of the OP-Amp and provides a start-up current (SUC) to the resistors R1 and R2 at an initial driving of the OP-Amp.

The MP must be turned on to provide the SUC at the initial driving of the OP-Amp. Only in that case, the resistors R1 and R2 are connected to the bias power Vcc and thus the SUC flows in the resistors R1 and R2.

If a signal on a logic level “high” is input to the gate node of the MP at the initial driving of the OP-Amp due to a high level of a bandgap reference voltage V_{BGR}, the MP is turned off. Consequently, the resistors R1 and R2 are not connected to the bias power Vcc, and thus the SUC does not flow in the resistors R1 and R2. As a result a start-up failure occurs.

The start-up failure of the bandgap reference voltage generator causes a rated bandgap reference voltage V_{BGR} not to be output. Thus, the rated bandgap reference voltage V_{BGR} is not applied to electric elements integrated into an IC element. As a result, it is impossible for the electric elements to normally operate.

The level of the bandgap reference voltage V_{BGR} becomes high at the initial driving due to a voltage offset Vos of an input voltage of the OP-Amp.

Computer simulation results of the bandgap reference voltage generator shown in FIG. 2 which verify the high level of V_{BGR} at the initial driving will be described in detail with reference to FIGS. 3A and 3B.

A rated bandgap reference voltage V_{BGR} of 2.5V must be output from a bandgap reference voltage generator designed as shown in FIG. 3A. Also, it was assumed that a bias power Vcc is 5V, and an input voltage input to a positive node of an OP-Amp includes a voltage offset Vos of −10 mV, 0 mV, or 10 mV.

FIG. 3B is a graph illustrating a bandgap reference voltage V_{BGR} output from the bandgap reference voltage generator shown in FIG. 3A to which an input voltage including a voltage offset Vos is gradually applied. As shown in FIG. 3B, if the voltage offset Vos is 0 mV or −10 mV, the bandgap reference voltage V_{BGR} becomes rated to be 2.5V. Thus, a problem does not occur. However, if the voltage offset Vos is 10 mV, the bandgap reference voltage V_{BGR} becomes 0.6V and thus does not reach 2.5V.

### SUMMARY OF THE INVENTION

Accordingly, the present general inventive concept addresses the above-mentioned problems, and an aspect of the present general inventive concept is to provide a bandgap reference voltage generator capable of starting up by itself without a start-up failure.

According to an aspect of the present invention, there is provided a bandgap reference voltage generator including: a reference voltage generator generating a bandgap reference voltage; a current provider providing a start-up current to the reference voltage generator using a predetermined power; and if the current provider fails to provide the start-up current to the reference voltage generator, a current providing support providing the start-up current to the reference voltage generator using the predetermined power used by the current provider.

The current providing support may provide an electric path between the predetermined power used by the current provider and the reference voltage generator so as to provide the start-up current to the reference voltage generator.

The current providing support may connect the reference voltage generator to the predetermined power used by the current provider through a resistor so as to provide the start-up current to the reference voltage generator.

If the current provider fails to provide the start-up current to the reference voltage generator, the current providing support may perform a switching operation to electrically connect the reference voltage generator to the predetermined power used by the current provider so as to provide the start-up current to the reference voltage generator.

If a level of the bandgap reference voltage generated by the reference voltage generator is within a predetermined range, the current provider may provide the start-up current to the reference voltage generator, and if the level of the bandgap reference voltage generated by the reference voltage generator is out of the predetermined range, the current providing support may perform the switching operation to electrically connect the reference voltage generator to the predetermined power used by the current provider.

If a voltage input to an operational amplifier of the reference voltage generator comprises a voltage offset, the level of the bandgap reference voltage generated by the reference voltage generator may be out of the predetermined range.

According to another aspect of the present invention, there is provided an integrated circuit element into which an electric element driven by receiving a bandgap reference voltage is integrated, including: a reference voltage generator generating the bandgap reference voltage to be applied to the electric element; a current provider providing a start-up current to the reference voltage generator using a predetermined power; and if the current provider fails to provide the start-up current to the reference voltage generator, a current providing support provides the start-up current to the reference voltage generator using the predetermined power used by the current provider.

The current providing support may provide an electric path between the predetermined power used by the current provider and the reference voltage generator so as to provide the start-up current to the reference voltage generator.

If the current provider fails to provide the start-up current to the reference voltage generator, the current providing support may perform a switching operation to electrically connect the reference voltage generator to the predetermined power used by the current provider so as to provide the start-up current to the reference voltage generator.

### BRIEF DESCRIPTION OF THE DRAWINGS

The above aspects and features of the present invention will be more apparent by describing certain exemplary embodiments of the present invention with reference to the accompanying drawings, in which:

FIG. 1 is a circuit diagram of a conventional bandgap reference voltage generator;

FIG. 2 is a circuit diagram of a conventional bandgap reference voltage generator capable of starting up by itself;

FIGS. 3A and 3B are a circuit diagram and a graph illustrating results of a computer simulation of the conventional bandgap reference voltage generator shown in FIG. 2;

FIG. 4 is a block diagram of a bandgap reference voltage generator without a start-up failure according to an exemplary embodiment of the present invention;

FIG. 5 is a circuit diagram of the bandgap reference voltage generator shown in FIG. 4 according to an exemplary embodiment of the present invention;

FIGS. 6A and 6B are a circuit diagram and a graph illustrating results of a computer simulation of the bandgap reference voltage generator shown in FIG. 5; and

FIG. 7 is a circuit diagram of the bandgap reference voltage generator shown in FIG. 4 according to another exemplary embodiment of the present invention.

### DETAILED DESCRIPTION OF THE EXEMPLARY EMBODIMENTS

Certain exemplary embodiments of the present invention will be described in greater detail with reference to the accompanying drawings.

In the following description, same drawing reference numerals are used for the same elements even in different drawings. The matters defined herein are described at a high-level of abstraction to provide a comprehensive yet clear understanding of the invention. It is also to be noted that it will be apparent to those ordinarily skilled in the art that the present invention is not limited to the description of the exemplary embodiments provided herein.

FIG. 4 is a block diagram of a bandgap reference voltage generator according to an exemplary embodiment of the present invention. The bandgap reference voltage generator is generally integrated along with other electric elements into an IC circuit. The bandgap reference voltage generator generates a bandgap reference voltage and applies the bandgap reference voltage to electric elements requiring the bandgap reference voltage.

The present bandgap reference voltage generator may start up by itself and may be designed so that a start-up failure does not occur during its start-up. Referring to FIG. 4, the present bandgap reference voltage generator includes a reference voltage generator 110, a SUC provider 120, and a SUC proving support 130.

The reference voltage generator 110 generates a bandgap reference voltage V_{BGR}. The bandgap reference voltage V_{BGR} generated by the reference voltage generator 110 is applied to other electric elements integrated into an IC element and fed back through the SUC provider 120 that will be described later to the reference voltage generator 110.

The SUC provider 120 provides a path through which an output of the reference voltage generator 110 is fed back to an input of the reference voltage generator 110. The SUC provider 120 also provides a SUC to the reference voltage generator 110 at an initial driving of the reference voltage generator 110 using a predetermined power.

However, there will be instances where the SUC provider 120 may not provide the SUC to the reference voltage generator 110. This is determined depending on a level of the bandgap reference voltage V_{BGR} output from the reference voltage generator 110 at the initial driving of the reference voltage generator 110. In other words, the SUC provider 120 may not provide the SUC to the reference voltage generator 110 depending on the level of the bandgap reference voltage V_{BGR}.

The SUC providing support 130 continuously provides a predetermined current to the reference voltage generator 110 using the predetermined power used by the SUC provider 120 to generate the SUC. In detail, the SUC providing support 130 electrically connects the reference voltage generator 110 to the predetermined power used by the SUC provider 120 to generate the SUC, i.e., provides an electric connection path between the reference voltage generator 110 and the predetermined power, so as to continuously provide the predetermined current to the reference voltage generator 110.

The predetermined current provided by the SUC providing support 130 to the reference voltage generator 110 at the initial driving may be used as the SUC provided to the reference voltage generator 110.

The SUC providing support 130 continuously provides the predetermined current to the reference voltage generator 110. In other words, even in a case where the SUC provider 120 fails to provide the SUC to the reference voltage generator 110, the SUC providing support 130 provides the SUC to the reference voltage generator 110. Thus, the present bandgap reference voltage generator can start up without a start-up failure due to the SUC providing support 130.

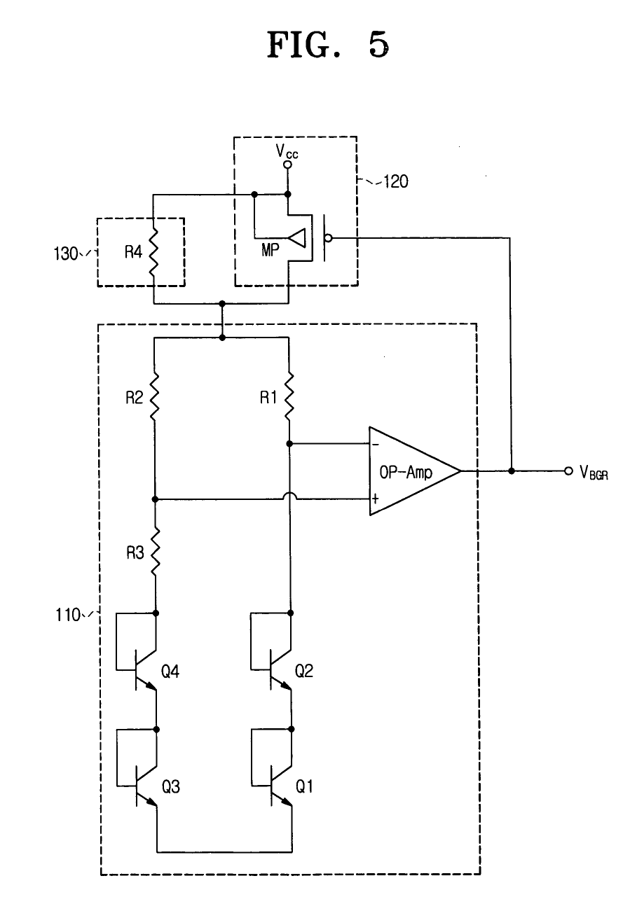

The exemplary bandgap reference voltage generator shown in FIG. 4 will now be described in more detail with reference to FIG. 5.

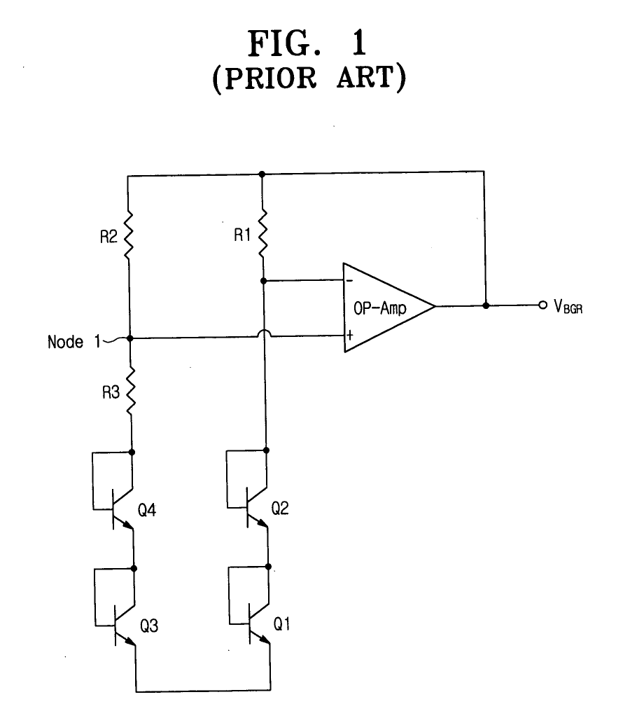

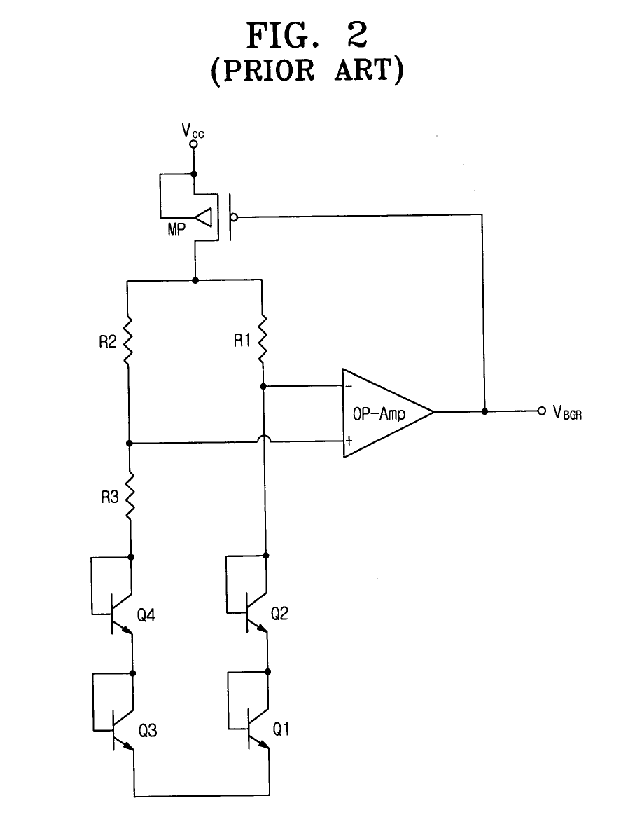

FIG. 5 is a circuit diagram of the bandgap reference voltage generator shown in FIG. 4 according to an exemplary embodiment of the present invention. Referring to FIG. 5, a reference voltage generator 110 includes an OP-AMP, resistors R1, R2, and R3, and bipolar transistors Q1, Q2, Q3, and Q4, and a SUC provider 120 includes a P-channel MOS FET (MP). Circuit operations of the reference voltage generator 110 and the SUC provider 120 have been described with reference to FIGS. 1 and 2, and thus their detailed descriptions will be omitted.

A SUC providing support 130 includes a resistor R4. As shown in FIG. 5, the SUC providing support 130 is realized using one resistor R4. However, it is to be noted that multiple resistors utilizing various connection schemes may be implemented to realize the SUC providing support 130.

The resistor R4 continuously provides a predetermined current to the resistors R1 and R2 using a bias power Vcc the MP uses to generate the SUC. In detail, the resistor R4 electrically connects the resistors R1 and R2 to the bias power Vcc, i.e., provides an electric connection path between the resistors R1 and R2 and the bias power Vcc, so as to continuously provide the predetermined current to the resistors R1 and R2.

The resistor R4 continuously provides the predetermined current to the resistors R1 and R2. In other words, even in a case where the MP fails to provide the SUC to the resistors R1 and R2, the resistor R4 provides the SUC to the resistors R1 and R2. A case where the MP fails to provide the SUC to the resistors R1 and R refers to a case where a level of the bandgap reference voltage V_{BGR} becomes high due to a voltage offset Vos of an input voltage of the OP-Amp at an initial driving, and thus a signal of a logic level “high” is input to a gate node of the MP, and finally the MP is turned off.

According to the present exemplary embodiment, although the MP fails to provide the SUC to the resistors R1 and R2 at the initial driving, the resistor R4 continuously provides the SUC to the resistors R1 and R2. Thus, a start-up failure does not occur.

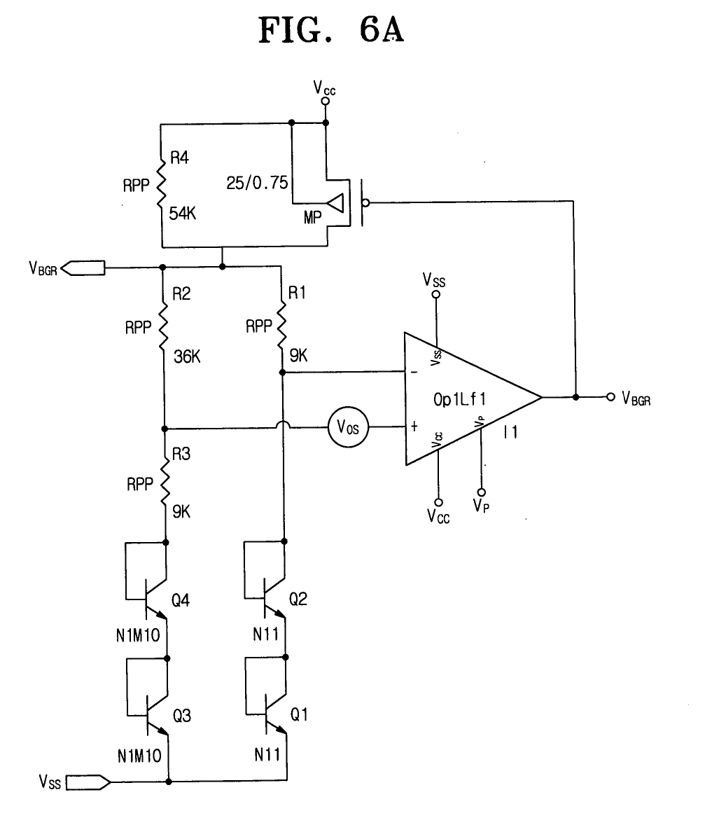

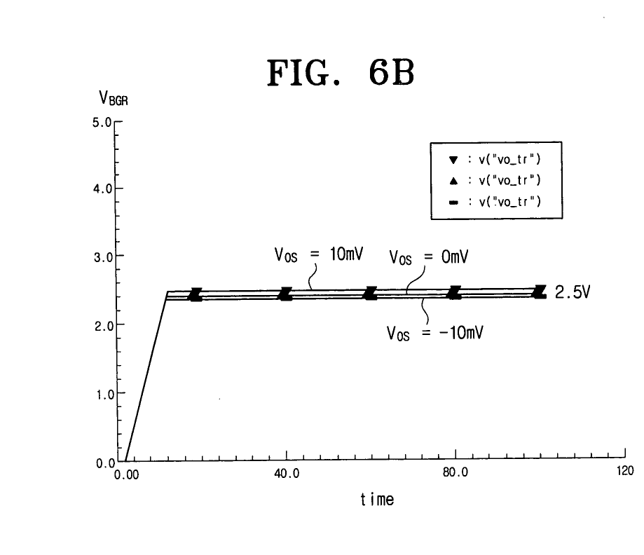

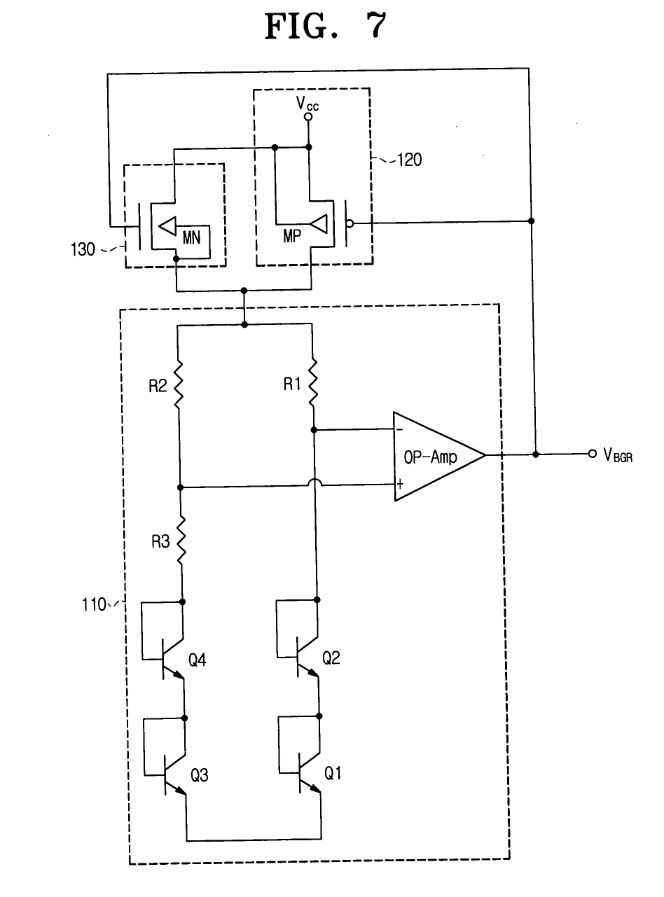

Computer simulation results of the bandgap reference voltage generator shown in FIG. 5 performed to verify the continuous supply of the SUC will be described in detail with reference to FIGS. 6A and 6B

A rated bandgap reference voltage V_{BGR} of 2.5V must be output from a bandgap reference voltage generator designed as shown in FIG. 6A. It was assumed that a bias power Vcc is 5V, and an input voltage input to a positive input node of the OP-Amp includes a voltage offset Vos of −10 mV, 0 mV, or 10 mV.

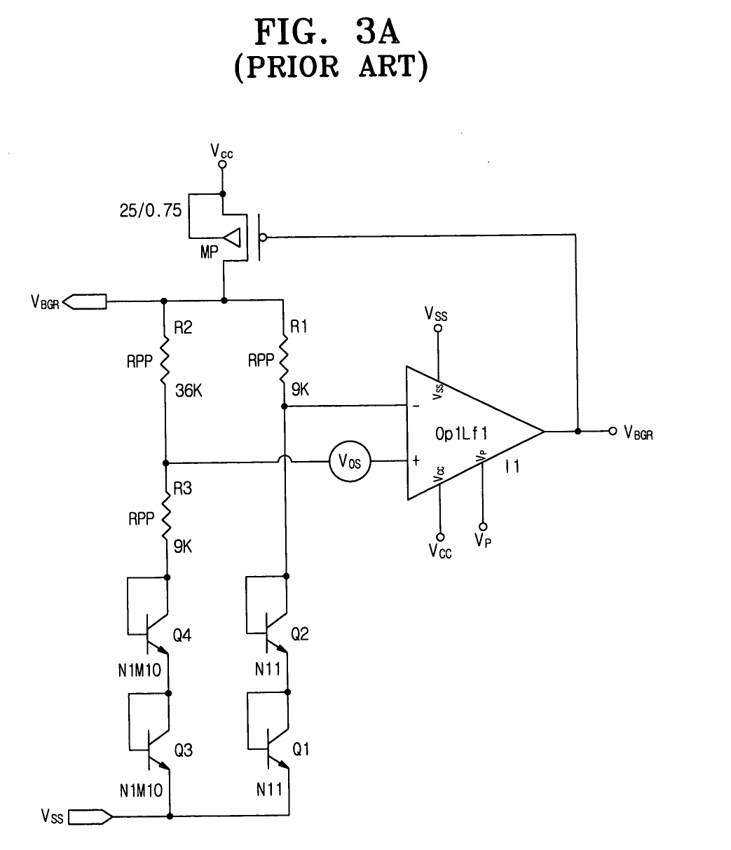

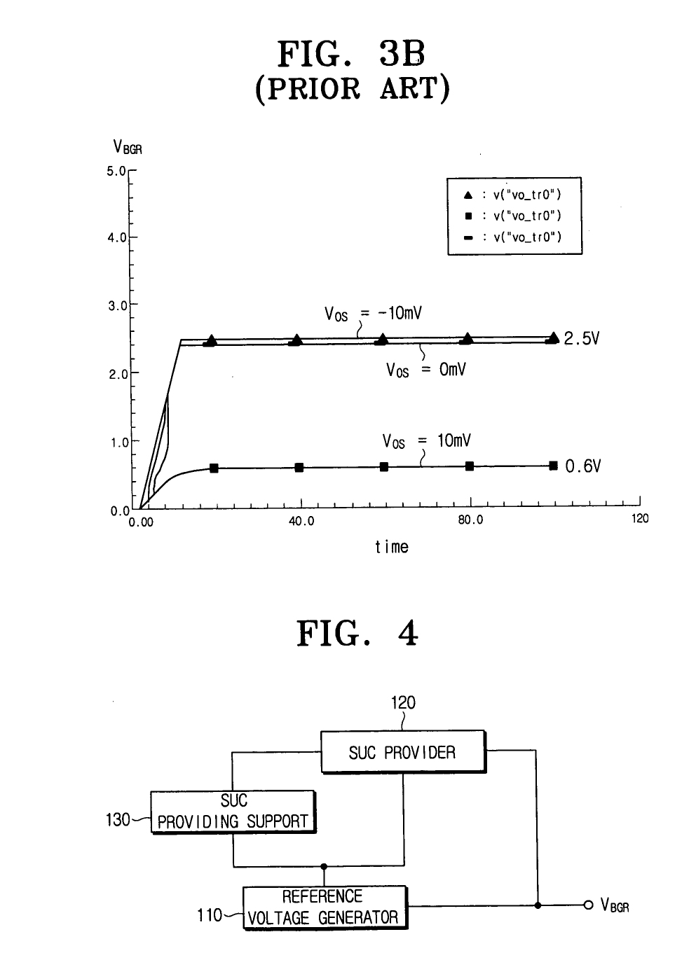

FIG. 6B is graph illustrating the bandgap reference voltage V_{BGR} output from the bandgap reference voltage generator shown in FIG. 6A to which the input voltage including the voltage offset Vos is gradually applied. As shown in FIG. 6B, the bandgap reference voltage V_{BGR} becomes rated to be 2.5V regardless of the voltage offset Vos. The result shown in FIG. 6B is unambiguously distinguishable from the result shown in FIG. 3B in that the bandgap reference voltage V_{BGR} becomes rated to be 2.5V even at the voltage offset Vos of 10 mV.

Another exemplary embodiment of the bandgap reference voltage generator shown in FIG. 4 will now be described in more detail with reference to FIG. 7.

A reference voltage generator 110 and a SUC provider 120 shown in FIG. 7 respectively perform the same circuit operations as the reference voltage generator 110 and the SUC provider 120 shown in FIG. 5, and thus their detailed descriptions will be omitted.

A SUC providing support 130 is different from the SUC providing support 130 shown in FIG. 5 in that it is realized using an N-channel MOS FET (MN). Gate, source, and drain nodes of the MN are respectively connected to an output node of an OP-Amp, ends of resistors R1 and R2, and a bias power Vcc.

In a case where an MP fails to provide the SUC to resistors R1 and R2, the MN provides a SUC to the resistors R1 and R2 using the bias power Vcc. A case where the MP fails to provide the SUC to the resistors R1 and R2 refers to a case where a level of a bandgap reference voltage V_{BGR} becomes high at an initial driving due to a voltage offset Vos of an input voltage input to the OP-Amp, and thus a signal on a logic level “high” is input to the gate node of the MP, and finally the Mp is turned off. In this case, a signal of a logic level “high” is input to the gate node of the MN. Here, since the MN is turned on, the resistors R1 and R2 are connected to the bias power Vcc. Thus, the SUC flows in the resistors R1 and R2.

Accordingly, in a case where the MP fails to provide the SUC to the resistors R1 and R2, the MN performs a switching operation to electrically connect the resistors R1 and R2 to the bias power Vcc so as to provide the SUC to the resistors R1 and R2.

In summary, if the level of the bandgap reference voltage V_{BGR} becomes high at the initial driving due to the voltage offset Vos of the input voltage input to the OP-Amp and thus the signals on the logic level “high” are input to the gate nodes of the MP and the MN, the Mp is turned off while the MN is turned on. Thus, the resistors R1 and R2 are connected through the MN to the bias power Vcc. As a result, the SUC flows in the resistors R1 and R2.

If the level of the bandgap reference voltage V_{BGR} becomes low at the initial driving and thus signals on a logic level “low” are input to the gate nodes of the MP and the MN, the MN is turned off while the MP is turned on. Thus, the resistors R1 and R2 are connected through the MP to the bias power Vcc. As a result, the SUC flows in the resistors R1 and R2.

According to the present exemplary embodiment, although the MP fails to provide the SUC to the resistors R1 and R2 at the initial driving, the MN provides the SUC to the resistors R1 and R2. Thus, a start-up failure does not occur.

Also in the present exemplary embodiment, though the SUC providing support 130 is realized with the MN, it may also be realized using another switching element.

As described above, when a bandgap reference voltage generator according to the present invention starts up by itself at an initial driving, a start-up failure does not occur. Thus, the bandgap reference voltage generator can output a rated bandgap reference voltage anytime. As a result, other electric elements integrated into an IC element can be supplied with the rated bandgap reference voltage and thus normally operate.

Also, a SUC providing support of the bandgap reference voltage generator can be realized using only resistors or transistors. Thus, a circuit structure of the bandgap reference voltage generator can be simplified and thus need not occupy a large volume. In addition, the SUC providing support of the bandgap reference voltage generator does not use any additional power. Thus, the bandgap reference voltage generator can be simply designed and consume only a small amount of power.

The foregoing embodiments and advantages are merely exemplary in nature and are not to be construed as limiting the present invention. The present teaching can be readily applied to other types of apparatuses. Also, the description of the exemplary embodiments of the present invention is intended to be illustrative, and therefore it does not limit the scope of the claims. Alternatives, modifications, and variations of the exemplary embodiments described herein will be readily apparent to those skilled in the art.

What is claimed is:

1. A bandgap reference voltage generator comprising:
a reference voltage generator unit which generates a bandgap reference voltage;
a current provider unit which provides a start-up current to the reference voltage generator unit using a power; and
a current providing support unit which provides the start-up current to the reference voltage generator unit,
wherein if the current provider unit fails to provide the start-up current to the reference voltage generator unit, the current providing support unit provides the start-up current to the reference voltage generator unit using the power used by the current provider unit.

2. The bandgap reference voltage generator of claim 1, wherein the current providing support unit provides an electric path between the power used by the current provider unit and the reference voltage generator unit to provide the start-up current to the reference voltage generator unit.

3. The bandgap reference voltage generator of claim 2, wherein the current providing support unit connects the reference voltage generator unit to the power used by the current provider unit through a resistor means for providing the start-up current to the reference voltage generator unit.

4. The bandgap reference voltage generator of claim 1, wherein if the current provider unit fails to provide the start-up current to the reference voltage generator unit, the current providing support unit performs a switching operation to electrically connect the reference voltage generator unit to the power used by the current provider unit to provide the start-up current to the reference voltage generator unit.

5. The bandgap reference voltage generator of claim 4, wherein:
if a level of the bandgap reference voltage generated by the reference voltage generator unit is within a predetermined range, the current provider provides the start-up current to the reference voltage generator unit; and
if the level of the bandgap reference voltage generated by the reference voltage generator unit is out of the predetermined range, the current providing support unit performs the switching operation to electrically connect the reference voltage generator unit to the predetermined power used by the current provider unit.

6. The bandgap reference voltage generator of claim 5, wherein if a voltage input to an operational amplifier of the reference voltage generator unit comprises a voltage offset, the level of the bandgap reference voltage generated by the reference voltage generator unit is out of the range.

7. An integrated circuit element into which an electric element driven by receiving a bandgap reference voltage is integrated, comprising:
a reference voltage generator unit which generates the bandgap reference voltage to be applied to the electric element;
a current provider unit which provides a start-up current to the reference voltage generator unit using a predetermined power; and
a current providing support unit which provides the start-up current to the reference voltage generator unit,
wherein if the current provider unit fails to provide the start-up current to the reference voltage generator unit, the current providing support unit provides the start-up current to the reference voltage generator unit using the predetermined power used by the current provider unit.

8. The integrated circuit element of claim 7, wherein the current providing support unit provides an electric path between the power used by the current provider unit and the reference voltage generator unit to provide the start-up current to the reference voltage generator unit.

9. The integrated circuit element of claim 7, wherein if the current provider unit fails to provide the start-up current to the reference voltage generator unit, the current providing support unit performs a switching operation to electrically connect the reference voltage generator unit to the power used by the current provider unit to provide the start-up current to the reference voltage generator unit.
